(19) United States
(12) Patent Application Publication
(10) Pub. No.: US 2005/0190040 A1
(43) Pub. Date: Sep. 1, 2005

(54) Keyless entry system in side-view mirror

(76) Inventors: Fred W. Huntzicker, Ann Arbor, MI (US); Clark E. McCall, Ann Arbor, MI (US)

Correspondence Address: CHRISTOPHER DEVRIES;General Motors Corporation, Legal Staff, Mail Code 482-C23-B21, P.O. Box 300, Detroit, MI, 48265-3000, US

(21) Appl. No.: 10/997,645

(22) Filed: Nov. 24, 2004

Related U.S. Application Data
(60) Provisional application No. 60/548,266, filed on Feb. 27, 2004.

(51) Int. Cl. H04Q 1/00; G05B 19/00

(52) U.S. Cl. 340/5.54; 340/5.72

(57) ABSTRACT

A keyless entry system for a vehicle includes a side-view mirror assembly and an input device integrated into the side-view mirror assembly. The input device includes an input interface that is operable to input a code. A controller receives the code and generates an action signal based on the code to initiate operation of a device of the vehicle.

### CROSS-REFERENCE TO RELATED APPLICATIONS

This application claims the benefit of U.S. Provisional Application No. 60/548,266, filed on Feb. 27, 2004. The disclosure of the above application is incorporated herein by reference.

### FIELD OF THE INVENTION

The present invention relates to keyless entry systems for vehicles, and more particularly to a keyless entry system integrated into a side-view mirror of a vehicle.

### BACKGROUND OF THE INVENTION

Keyless entry systems enable access to a vehicle interior and/or remote activation of vehicle accessories. Traditionally, keyless entry systems include a keypad mounted near the door handle or a key-fob attached to a key ring. The key-fob enables remote access and/or accessory activation, however, an operator must be in physical possession of the key ring. A keypad enables an operator to access the vehicle and or remotely activate accessories without the key-ring in hand.

Keypad keyless entry systems are traditionally installed on the driver side door. An operator inputs a code to unlock the vehicles doors and or activate vehicle accessories. For example, the trunk can be opened and the interior lights turned on. Keypad keyless entry systems enable vehicle access and/or accessory activation without requiring the vehicle key. In this manner, a child, a friend or a service technician can access the vehicle interior without the ability to start the vehicle.

Keypad keyless entry systems generally require a keypad having multiple keys. The multiple keys each include indicia indicating a particular code character. As a result, traditional keypad keyless entry systems diminish the aesthetic quality of the vehicle. More particularly, the keypad breaks the vehicle styling lines and color schemes.

### SUMMARY OF THE INVENTION

Accordingly, the present invention provides a keyless entry system for a vehicle. The keyless entry system includes a side-view mirror assembly and an input device integrated into the side-view mirror assembly. The input device includes an input interface that is operable to input a code that initiates operation of a device of said vehicle.

In one feature, the keyless entry system further includes indicia associated with said input interface.

In other features, the side-view mirror assembly includes a mirror support that is positionable between a dormant position and an entry position. The input device is integrated into the mirror support and is covered by a mirror housing when the mirror support is in said dormant position and is exposed when the mirror support is in the entry position. Alternatively, an indicator is integrated into the mirror support and is covered by a mirror housing when the mirror support is in the dormant position and is exposed when the mirror support is in the entry position.

In other features, the input interface is integrated into a mirror surface as a touch pad. The touch pad is operable in a visible mode and one of a translucent mode and an invisible mode. A display is integrated into the mirror surface. The display is operable in a visible mode and one of a translucent mode and an invisible mode.

In still other features, the keyless entry system further includes a display that is integrated into the mirror surface. The display provides indicia corresponding to each of the input pads of the keypad. The display is operable in a visible mode and one of a translucent mode and an invisible mode.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic illustration of a vehicle door having a side-view mirror with an integrated keyless entry system according to the present invention;

FIG. 2 is a front view of the side-view mirror including the keyless entry system mounted to an external surface of a mirror housing;

FIG. 3 is a front view of the side-view mirror including the keyless entry system mounted to an internal surface of a mirror housing;

FIG. 4 is a cross-sectional side view of the side-view mirror including an alternative keyless entry system according to the present invention;

FIG. 5 is a cross-sectional side view of the side-view mirror of FIG. 4 illustrating the mirror pivoted to an entry position;

FIG. 6 is a cross-sectional side view of the side-view mirror including another alternative keyless entry system according to the present invention;

FIG. 7 is a cross-sectional side view of the side-view mirror of FIG. 6 illustrating the mirror pivoted to an entry position;

FIG. 8 is a front view of the side-view mirror including still another alternative keyless entry system according to the present invention;

FIG. 9 is a front view of the side-view mirror including still another alternative keyless entry system according to the present invention;

FIG. 10 is a front view of the side-view mirror including yet another alternative keyless entry system according to the present invention;

FIG. 11 is a front view of the side-view mirror including a combined keyless entry system and turn signal indicator integrated into the mirror housing;

FIG. 12 is a front view of the side-view mirror including the combined keyless entry system and turn signal indicator integrated into a mirror surface; and

FIG. 13 is a front view of the side-view mirror including the combined keyless entry system and turn signal indicator attached to the mirror housing.

### DETAILED DESCRIPTION OF THE PREFERRED EMBODIMENTS

The following description of the preferred embodiment is merely exemplary in nature and is in no way intended to limit the invention, its application, or uses. For purposes of clarity, the same reference numbers will be used in the drawings to identify similar elements. As used herein, the term module refers to an application specific integrated circuit (ASIC), an electronic circuit, a processor (shared, dedicated, or group) and memory that execute one or more software or firmware programs, a combinational logic circuit, or other suitable components that provide the described functionality.

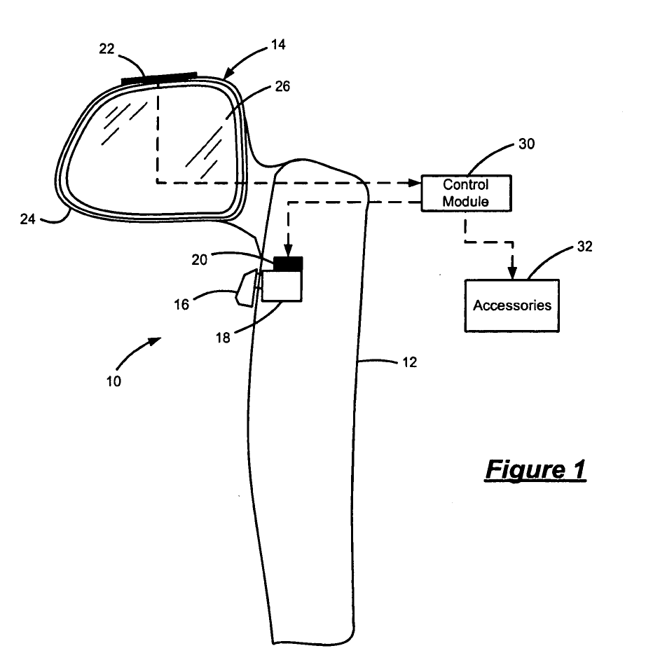

Referring now to FIG. 1, an exemplary vehicle door assembly 10 is illustrated. The vehicle door assembly 10 includes a door panel 12, a side-view mirror assembly 14, a door handle 16, a latching mechanism 18, a locking mechanism 20 and an integrated keyless entry system 22. The vehicle door assembly 10 is movable between an open position and a closed position relative to a vehicle frame (not shown). The door handle 16 is mechanically or electrically connected to the latching mechanism 18 in a manner known in the art. The locking mechanism 20 is in mechanical or electrical connection with the latching mechanism 18. The locking mechanism 20 is selectively actuated to lock the vehicle door assembly 12 in the closed position, as discussed in further detail below.

The vehicle door assembly 10 is selectively latched in the closed position by the latching mechanism 18. Actuation of the door handle 16 induces the latching mechanism 18 to unlatch the vehicle door assembly 10. In this manner, the movement of the vehicle door assembly 10 to the open position is enabled. The locking mechanism 20 has a locked mode and an unlocked mode. In the locked mode, the locking mechanism 20 prohibits the latching mechanism 18 from unlatching the vehicle door assembly 10. In the unlocked mode, the vehicle door assembly 10 may be selectively unlatched.

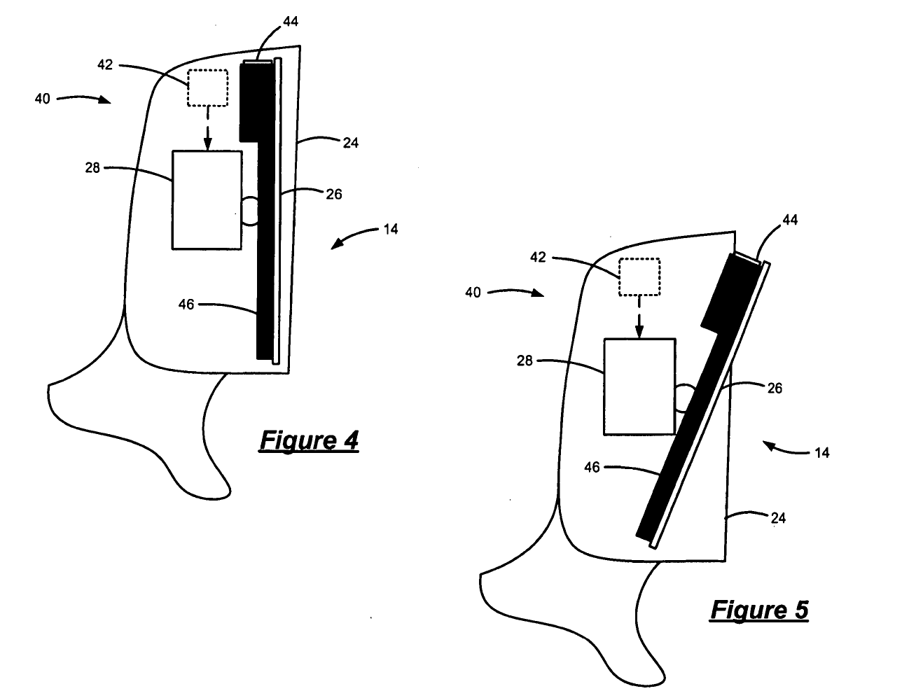

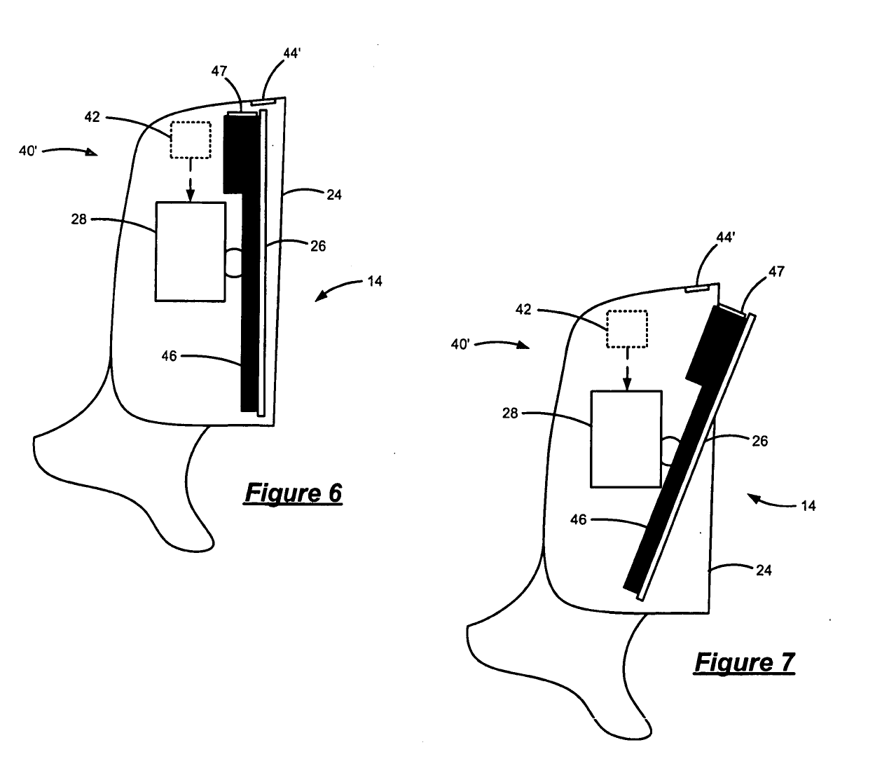

The side-view mirror assembly 14 includes the keyless entry system 22, a mirror housing 24, a mirror 26 and an actuator 28 (see FIGS. 4 and 5). The mirror housing 24 provides a decorative, aerodynamic covering and protects the keyless entry system 22, the mirror 26, the actuator 28 and other components of the side-view mirror assembly 14. The actuator 28 is remotely operated to adjust a position of the mirror 26.

The keyless entry system 22 is integrated into the side-view mirror assembly 14, as described in further detail below. Integration of the keyless entry system 22 in the side-view mirror assembly 14 improves vehicle aesthetics. More particularly, the keyless entry system 22 is either integrated as decorative features of the side-view mirror assembly 14 or is hidden within the side-view mirror assembly 14, as described in further detail below.

The keyless entry system 22 enables an operator to input a security code to affect the security settings of the vehicle. For example, by inputting the security code, the operator can turn off an alarm system or switch the locking mechanism 20 between locked and unlocked modes without physically inserting a key into the door handle 16 in the traditional manner. It is anticipated that the security code is a private code selected by the operator and akin to a personal identification number (PIN).

It is also anticipated that the keyless entry system 22 enables an operator to input function codes to affect vehicle functions. By inputting a function code, the operator can activate a vehicle function without the key and without having to enter the vehicle. For example, the keyless entry system 22 can be used to unlock a trunk, activate interior lights, headlights and/or hazard lights, slide windows up/down and the like. It is anticipated that the function codes are pre-set by the vehicle manufacturer such that the same function codes initiate the same functions across all vehicle platforms. It is further anticipated, however, that the security code must be first input before the function codes become operable. In this manner, an operator can only activate a function after inputting the proper security code.

A control module 30 processes signals (i.e., security and/or function codes) from the keyless entry system 22 and generates control signals to the locking mechanism 20 and/or accessories 32. The accessories 32 can include, but are not limited to a trunk latch, interior lights, headlights, hazard lights, window actuators, radio, A/C system, vehicle starter, seat heaters and the like. In general, an operator inputs a coded signal (i.e., security and/or function) using the keyless entry system 22. The coded signal is received by the control module 30, which generates a corresponding control signal. In this manner, the operator is able to unlock/lock the vehicle door assembly 10 and/or operate the vehicle accessories 32 without the key or having to enter the vehicle.

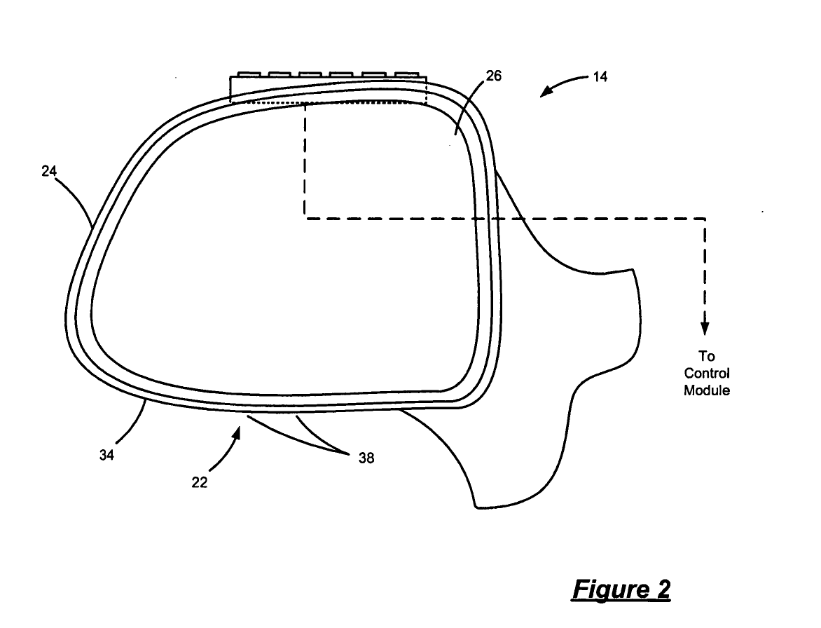

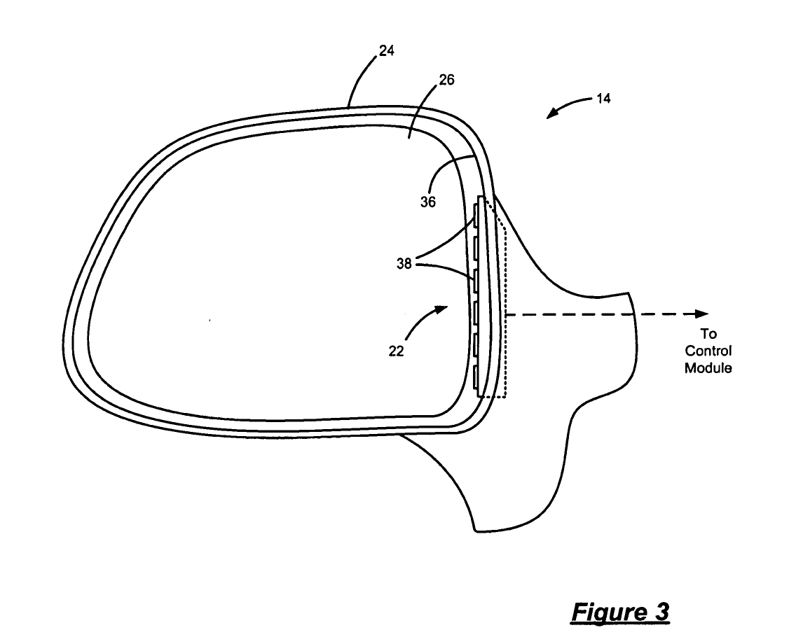

Referring now to FIGS. 2 and 3, the keyless entry system 22 is discretely mounted to the mirror housing 24. The keyless entry system 22 can be mounted through an external surface 34 of the mirror housing 24 (see FIG. 2) or through an internal surface 36 of the mirror housing 24 (see FIG. 3). The keyless entry system 22 includes a plurality of input pads 38. The input pads 38 are provided as decorative features including, but not limited to, bumps, dips, grooves, surface finishes (e.g., smooth, textured, rough). The operator inputs a desired code (i.e., security and/or function) using the input pads 38. For example, if the operator would like the vehicle door assembly 10 unlocked, the security code is input. If another function is desired, an alternative function code is input after the security code has been input. It is also anticipated that the input pads 38 can include individual designations, symbols or some form of indicia to differentiate one input pad 38 from another. The indicia can be provided as visual indicia (e.g., varying colors, numbers, letters or characters) or physical, brail-like indicia (e.g., bumps, grooves).

Referring now to FIGS. 4 and 5, an alternative keyless entry system 40 is illustrated. The alternative keyless entry system 40 includes an activation pad 42 and input pads 44. More specifically, the input pads 44 are integrated into a mirror support 46 that holds the mirror 26 in place. The mirror support 46 is pivotally positioned by the actuator 28 between a dormant position (see FIG. 4) and an entry position (see FIG. 5). When the mirror 26 is in the dormant position, the input pads 44 are covered from view by the mirror housing 24. Depression of the activation pad 42 induces the actuator 28 to move the mirror support 46 and the mirror 26 to the entry position. In the entry position, the input pads 44 are accessible by the operator.

Referring now to FIGS. 6 and 7, another alternative keyless entry system 40′ is illustrated. The keyless entry system 40′ includes an activation pad 42, input pads 44′ and keypad indicators 47. More specifically, the keypad indicators 47 are integrated into the mirror support 46. The mirror support 46 is pivotally positioned by the actuator 28 between a dormant position (see FIG. 6) and an entry position (see FIG. 7). When the mirror 26 is in the dormant position, the keypad indicators 47 are covered from view by the mirror housing 24. Depression of the activation pad 42 induces the actuator 28 to move the mirror support 46 and the mirror 26 to the entry position. In the entry position, the keypad indicators 47 are viewable by the operator. The input pads 44′ themselves are preferably minimally labeled, inconspicuous or otherwise integrated into the aesthetic design of the mirror housing 24. It is further anticipated that the key pads 44′ themselves can initiate actuation of the mirror support 46 to the entry position, thereby relieving the need for the separate activation pad 42.

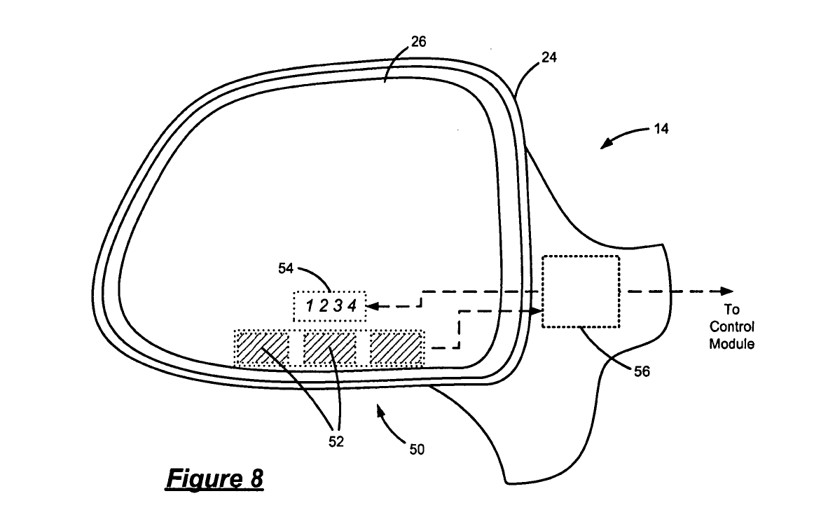

Referring now to FIG. 8, another alternative keyless entry system 50 is illustrated. The keyless entry system 50 includes a plurality of touch pads 52 and a display 54 integrated into the mirror 26. The keyless entry system 50 is operable in a dormant mode and an entry mode. In the dormant mode, the touch pads 52 and display 54 are translucent and are preferably invisible. As used herein, the term translucent indicates a touch pad resolution and/or display resolution that enable reflection of an image from the mirror surface while the touch pads and/or display are at least partially visible. In this manner, the entire mirror surface reflects an unobstructed side-view image. The keyless entry system 50 switches to the entry mode when the operator either touches or places their hand in proximity to the mirror surface or the portion of the mirror surface where the touch pads 52 are located. In this manner, the mirror 26 functions as a touch-screen, whereby the display 54 and touch pads 52 illuminate or become otherwise visible upon switching to the entry mode. It is anticipated that the touch pad and display resolution can vary between a full resolution (i.e., visible and obstructing image reflection from mirror surface in area of the touch pads 52 and the display 54), a partial resolution (i.e., partially visible) to a zero-resolution (i.e., invisible).

The operator actuates the keyless entry system 50 using the touch pads 52. A code can be sent directly to the control module 30 for executing the desired function. Alternatively, a secondary processor 56 can be provided. The secondary processor 56 relays the desired code to the control module 30 and sends a message signal to the display 54, which displays a message corresponding to the code entered. The keyless entry system 50 switches back to the dormant mode if the mirror 26 or touch pads 52 have not been touched for a threshold time period.

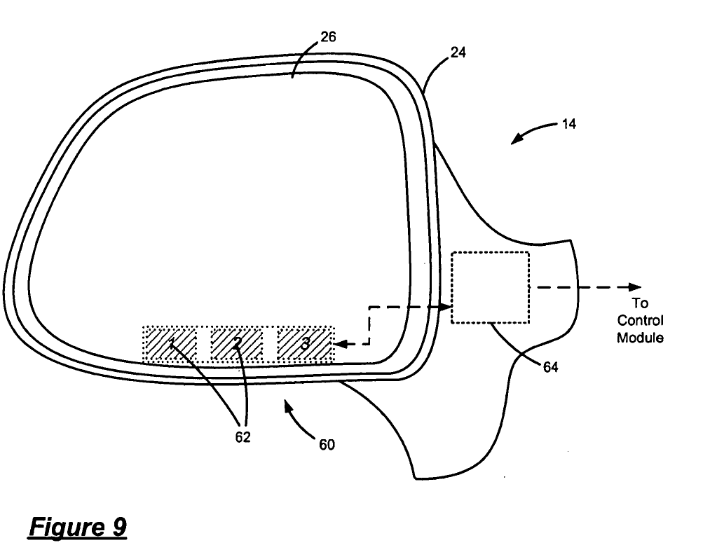

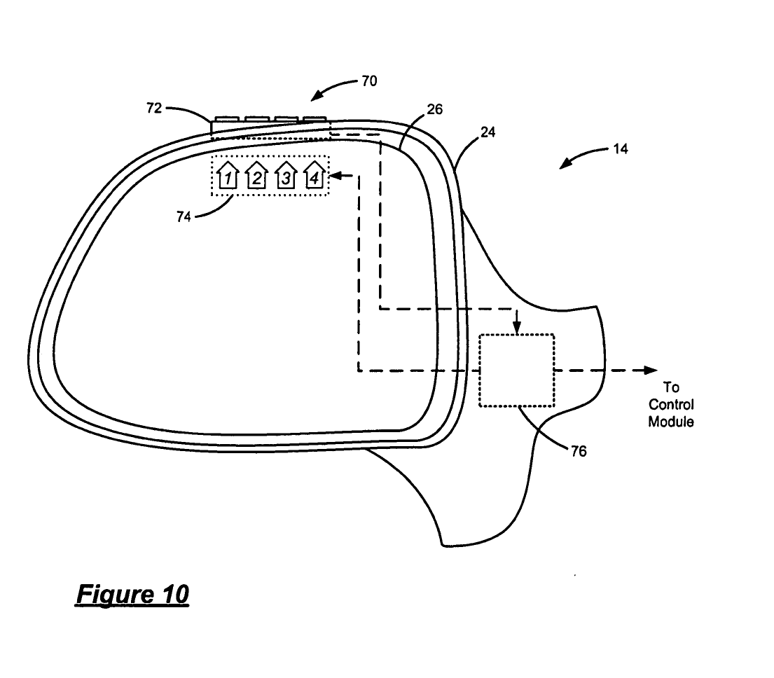

Referring now to FIG. 9, still another alternative keyless entry system 60 is illustrated. The keyless entry system 60 includes a plurality of touch pads 62 integrated into the mirror 26. The touch pads 62 include variable indicia that differentiate each. The keyless entry system 60 is operable in a dormant mode and an entry mode. In the dormant mode, the touch pads 62 are translucent and are preferably invisible. In this manner, the entire mirror surface reflects an unobstructed side-view image. The keyless entry system 60 switches to the entry mode when the operator either touches or places their hand in proximity to the mirror surface or the portion of the mirror surface where the touch pads 62 are located. It is anticipated that the touch pad resolution can vary between a full resolution (i.e., visible and obstructing image reflection from mirror surface in area of the touch pads 62), a partial resolution (i.e., partially visible) to a zero-resolution (i.e., invisible).

The operator actuates the keyless entry system 60 using the touch pads 62. A code can be sent directly to the control module 30 for executing the desired function. Alternatively, a secondary processor 64 can be provided. The secondary processor 64 relays the desired code to the control module 30 and sends a message signal to the touch pads 62 to correspondingly vary the indicia associated with each. The indicia displays a message corresponding to the code entered. The keyless entry system 60 switches back to the dormant mode if the mirror 26 or touch pads 62 have not been touched for a threshold time period.

Referring now to FIG. 10, yet another alternative keyless entry system 70 is illustrated. The keyless entry system 70 includes a plurality of input pads 72 attached to the mirror housing 24 and a display 74 integrated into the mirror 26. The keyless entry system 70 is operable in a dormant mode and an entry mode. In the dormant mode, the display 74 is translucent and is preferably invisible. In this manner, the entire mirror surface reflects an unobstructed side-view image. The keyless entry system 70 switches to the operative mode when the operator either touches or places their hand in proximity to the mirror surface or the portion of the mirror surface where the input pads 72 are located. It is anticipated that the display resolution can vary between a full resolution (i.e., visible and obstructing image reflection from mirror surface in area of the display 74), a partial resolution (i.e., partially visible) to a zero-resolution (i.e., invisible). The input pads 72 themselves are preferably minimally labeled, inconspicuous or otherwise integrated into the aesthetic design of the mirror housing 24.

The operator actuates the keyless entry system 70 using the touch pads 72. A code can be sent directly to the control module 30 for executing the desired function. Alternatively, a secondary processor 76 can be provided. The secondary processor 76 relays the desired code to the control module 30 and sends a message signal to the display 74, which displays a message corresponding to the code entered. The keyless entry system 70 switches back to the dormant mode if the touch pads 72 have not been touched for a threshold time period.

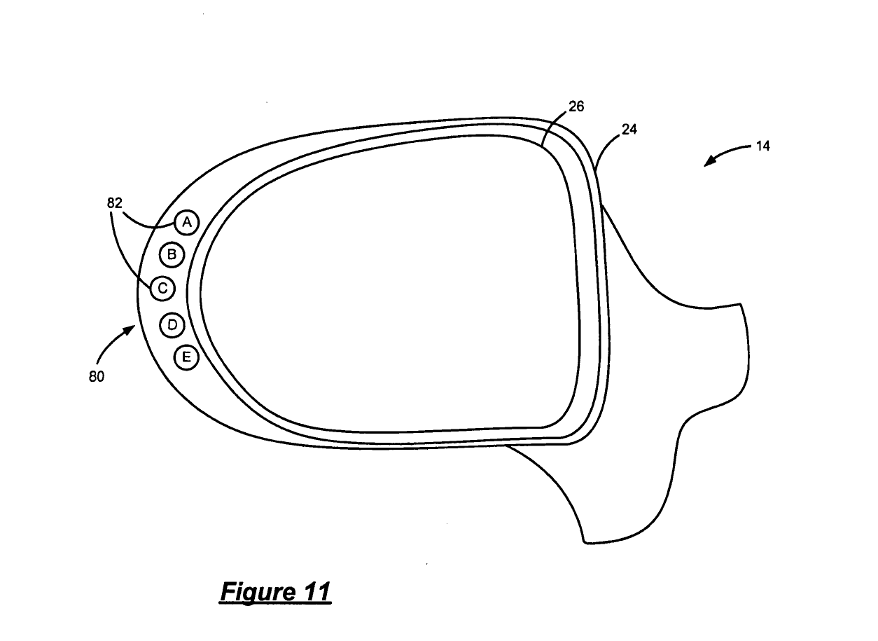

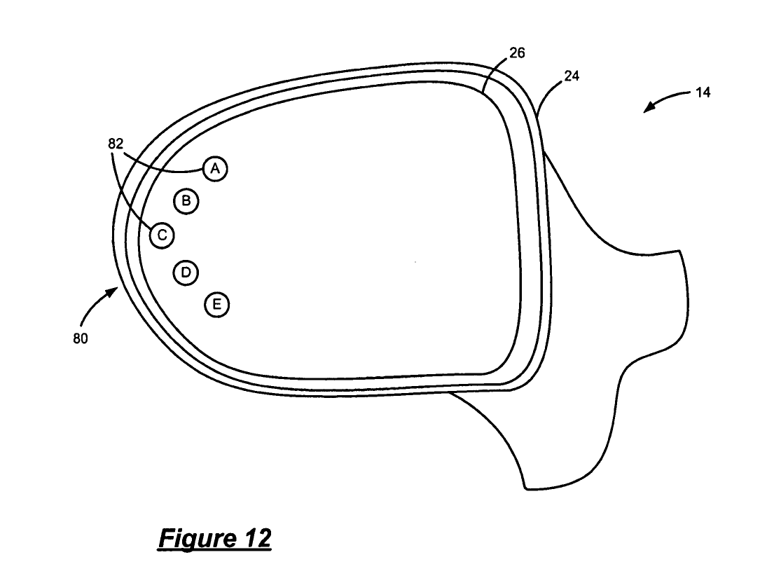

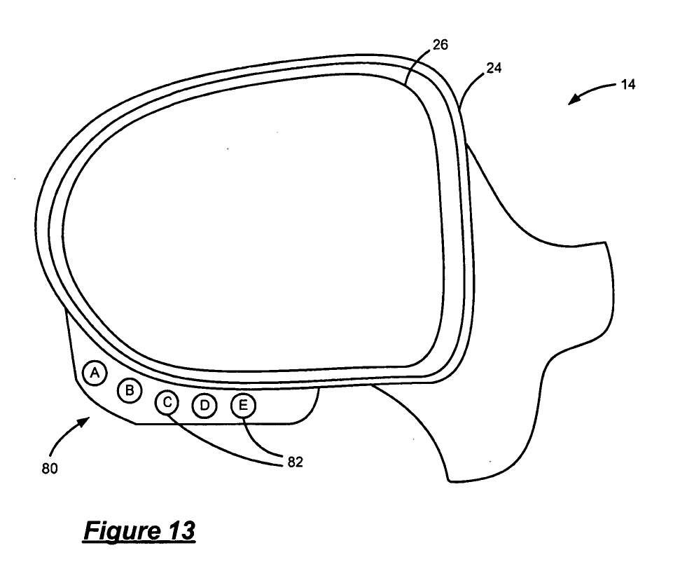

Referring now to FIG. 11 through 13, the present invention also provides a combined keyless entry system and turn signal indicator 80 that is implemented in the side-view mirror assembly 14. As illustrated in FIG. 11, the combined keyless entry system and turn signal indicator 80 includes a series of light sources 82 (e.g., light-emitting diodes (LEDs)) integrated into the mirror housing 24. The light sources 82 are selectively illuminated to indicate a driver's intention to turn. Additionally, the light sources 82 function as input interfaces 82 for inputting a security code and/or a function code, as described in detail above. The light sources 82 can include indicia provided as visual indicia (e.g., varying colors, numbers, letters or characters) or physical, brail-like indicia (e.g., bumps, grooves). The indicia differentiate one input interface 82 from another. FIG. 12 illustrates the combined keyless entry system and turn signal indicator 80 integrated into the mirror 26 and FIG. 13 illustrates the combined keyless entry system and turn signal indicator 80 attached to the mirror housing 24.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

1. A keyless entry system for a vehicle, comprising:
a side-view mirror assembly; and
an input device integrated into said side-view mirror assembly and including an input interface that is operable to input a code to initiate operation of a device within said vehicle.

2. The keyless entry system of claim 1 further comprising indicia associated with said input interface.

3. The keyless entry system of claim 1 wherein said side-view mirror assembly includes a mirror support that is positionable between a dormant position and an entry position.

4. The keyless entry system of claim 3 wherein said input device is integrated into said mirror support and is covered by a mirror housing when said mirror support is in said dormant position and is exposed when said mirror support is in said entry position.

5. The keyless entry system of claim 3 wherein an indicator is integrated into said mirror support and is covered by a mirror housing when said mirror support is in said dormant position and is exposed when said mirror support is in said entry position.

6. The keyless entry system of claim 1 wherein said input device is integrated into a mirror surface.

7. The keyless entry system of claim 6 wherein said input interface is operable in a visible mode and one of a translucent mode and an invisible mode.

8. The keyless entry system of claim 6 further comprising a display that is integrated into said mirror surface.

9. The keyless entry system of claim 8 wherein said display is operable in a visible mode and one of a translucent mode and an invisible mode.

10. The keyless entry system of claim 1 further comprising a display that is integrated into said mirror surface, said display providing indicia corresponding to said input interface.

11. The keyless entry system of claim 10 wherein said display is operable in a visible mode and one of a translucent mode and an invisible mode.

12. A door assembly of a vehicle, comprising:
a door;
a side-view mirror assembly attached to said door; and
a keyless entry system having an input device integrated into said side-view mirror assembly and including an input interface that is operable to input a code that is sent to a control module, which generates an action signal based on said code to initiate operation of a device of said vehicle.

13. The door assembly of claim 12 further comprising indicia associated with said input interface.

14. The door assembly of claim 12 wherein said side-view mirror assembly includes a mirror support that is positionable between a dormant position and an entry position.

15. The door assembly of claim 14 wherein said input device is integrated into said mirror support and is covered by a mirror housing when said mirror support is in said dormant position and is exposed when said mirror support is in said entry position.

16. The door assembly of claim 14 wherein an indicator is integrated into said mirror support and is covered by a mirror housing when said mirror support is in said dormant position and is exposed when said mirror support is in said entry position.

17. The door assembly of claim 12 wherein said input device is integrated into a mirror surface.

18. The door assembly of claim 17 wherein said input interface is operable in a visible mode and one of a translucent mode and an invisible mode.

19. The door assembly of claim 17 further comprising a display that is integrated into said mirror surface.

20. The door assembly of claim 19 wherein said display is operable in a visible mode and one of a translucent mode and an invisible mode.

21. The door assembly of claim 12 further comprising a display that is integrated into said mirror surface, said display providing indicia corresponding to said input interface.

22. The door assembly of claim 21 wherein said display is operable in a visible mode and one of a translucent mode and an invisible mode.

23. The door assembly of claim 12 wherein said device includes a locking mechanism that includes a locked mode to lock said door in a closed position and an unlocked mode to enable said door to open to an open position.

24. The door assembly of claim 23 said action signal transitions said locking mechanism between said locked mode and said unlocked mode.

25. A mirror assembly for a vehicle, comprising:
a mirror housing;
a mirror supported within said mirror housing; and
a keyless entry system including an input device integrated into said mirror housing and including an input interface that is operable to input a code that is sent to a control module, which generates an action signal based on said code to initiate operation of a device of said vehicle.

26. The mirror assembly of claim 25 further comprising indicia associated with said input interface.

27. The mirror assembly of claim 25 wherein said side-view mirror assembly includes a mirror support that is positionable between a dormant position and an entry position.

28. The mirror assembly of claim 27 wherein said input device is integrated into said mirror support and is covered by a mirror housing when said mirror support is in said dormant position and is exposed when said mirror support is in said entry position.

29. The mirror assembly of claim 27 wherein an indicator is integrated into said mirror support and is covered by a mirror housing when said mirror support is in said dormant position and is exposed when said mirror support is in said entry position.

30. The mirror assembly of claim 25 wherein said input interface is integrated into a mirror surface as a touch pad.

31. The mirror assembly of claim 30 wherein said touch pad is operable in a visible mode and one of a translucent mode and an invisible mode.

32. The mirror assembly of claim 30 further comprising a display that is integrated into said mirror surface.

33. The mirror assembly of claim 32 wherein said display is operable in a visible mode and one of a translucent mode and an invisible mode.

34. The mirror assembly of claim 25 further comprising a display that is integrated into said mirror surface, said display providing indicia corresponding to said input interface.

35. The mirror assembly of claim 34 wherein said display is operable in a visible mode and one of a translucent mode and an invisible mode.
